(19) United States
(12) Patent Application Publication
(10) Pub. No.: US 2024/0382842 A1
(43) Pub. Date: Nov. 21, 2024

(54) VIDEO GAME PERIPHERAL DEVICE, SYSTEM AND METHOD

(71) Applicant: Sony Interactive Entertainment Inc., Tokyo (JP)

(72) Inventors: Maria Chiara Monti, London (GB); Daniel Israel Pereira Jimenez, London (GB); Navin Kamath, London (GB); Jesus Lucas Barcias, London (GB); Michael Eder, London (GB); David Erwan Damien Uberti, London (GB); Mandana Jenabzadeh, London (GB); Pierluigi Vito Amadori, London (GB)

(73) Assignee: Sony Interactive Entertainment Inc., Tokyo (JP)

(21) Appl. No.: 18/662,300

(22) Filed: May 13, 2024

(30) Foreign Application Priority Data
May 17, 2023 (GB) 2307338.0

(51) Int. Cl. A63F 13/28; A63F 13/212; A63F 13/23

(52) U.S. Cl. CPC A63F 13/28; A63F 13/23; A63F 13/212; A63F 2300/8082

(57) ABSTRACT

A video game peripheral device includes an electromagnet and circuitry, the circuitry being configured to: receive data from a data processing apparatus executing a video game application; based on the received data, control an electric current supplied to the electromagnet to control a magnetic interaction between the electromagnet and a magnetic material of a second video game peripheral device wearable or holdable by a user.

### BACKGROUND

### Field of the Disclosure

This disclosure relates to a video game peripheral device, system and method.

### Description of the Related Art

The “background” description provided is for the purpose of generally presenting the context of the disclosure. Work of the presently named inventors, to the extent it is described in the background section, as well as aspects of the description which may not otherwise qualify as prior art at the time of filing, are neither expressly or impliedly admitted as prior art against the present disclosure.

Immersive video games, such as those that use augmented reality (AR) and virtual reality (VR), provide innovative ways for players to interact with virtual worlds.

For example, in AR games, virtual objects or characters may be superimposed in real time on captured images of a user's real world environment. This allows the user to experience an alternative version of their real world environment in which games can be played. In VR games, users are able to experience an entirely virtual world through audio, visual and/or haptic output provided to the user.

AR and VR games may be provided to users by way of a set of suitable apparatuses such as the PlayStation® VR2 headset (an example of a head-mountable display, HMD) and controllers. However, there is a desire to further enhance such immersive video game experiences.

### SUMMARY

The present disclosure is defined by the claims.

### BRIEF DESCRIPTION OF THE DRAWINGS

Non-limiting embodiments and advantages of the present disclosure are explained with reference to the following detailed description taken in conjunction with the accompanying drawings, wherein:

FIG. 1 schematically shows an example entertainment system;

FIGS. 2A and 2B schematically show example components associated with the entertainment system;

FIG. 3 schematically shows an example video game peripheral system;

FIGS. 4A and 4B schematically show example output images of an augmented reality (AR) video game;

FIG. 5 schematically shows a first example electromagnetic pad;

FIG. 6 schematically shows a second example electromagnetic pad; and

FIG. 7 shows an example method of controlling a video game peripheral device.

Like reference numerals designate identical or corresponding parts throughout the drawings.

### DETAILED DESCRIPTION OF THE EMBODIMENTS

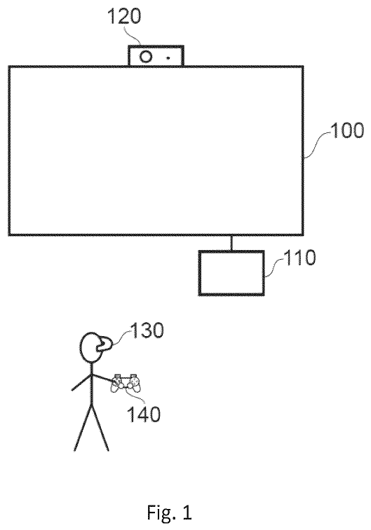

FIG. 1 schematically illustrates an entertainment system suitable for implementing one or more of the embodiments of the present disclosure. Any suitable combination of devices and peripherals may be used to implement embodiments of the present disclosure, rather than being limited only to the configuration shown.

A display device 100 (e.g. a television or monitor), associated with a games console 110, is used to display content to one or more users. A user is someone who interacts with the displayed content, such as a player of a game, or, at least, someone who views the displayed content. A user who views the displayed content without interacting with it may be referred to as a viewer. This content may be a video game, for example, or any other content such as a movie or any other video content. The games console 110 is an example of a content providing device or entertainment device; alternative, or additional, devices may include computers, mobile phones, set-top boxes, and physical media playback devices, for example. In some embodiments the content may be obtained by the display device itself-for instance, via a network connection or a local hard drive.

One or more video and/or audio capture devices (such as the integrated camera and microphone 120) may be provided to capture images and/or audio in the environment of the display device. While shown as a separate unit in FIG. 1, it is considered that such devices may be integrated within one or more other units (such as the display device 100 or the games console 110 in FIG. 1).

In some implementations, an additional or alternative display device such as a head-mountable display (HMD) 130 may be provided. Such a display can be worn on the head of a user, and is operable to provide augmented reality or virtual reality content to a user via a near-eye display screen. A user may be further provided with a video game controller 140 which enables the user to interact with the games console 110. This may be through the provision of buttons, motion sensors, cameras, microphones, and/or any other suitable method of detecting an input from or action by a user.

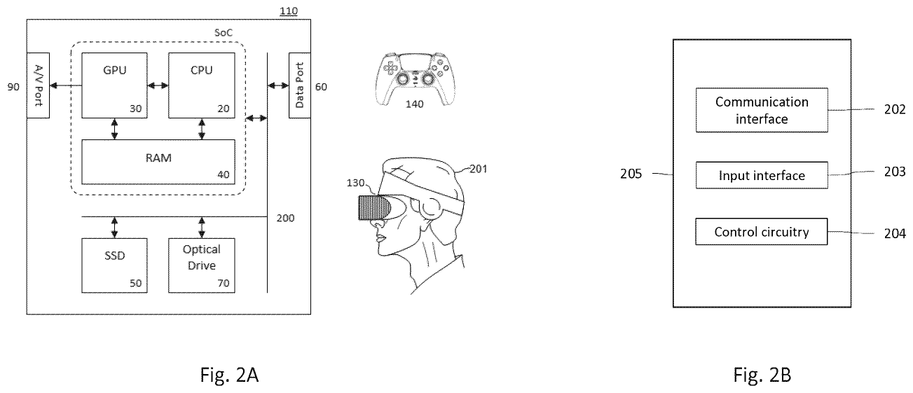

FIG. 2A shows an example of the games console 110. An example is the Sony® PlayStation 5® (PS5). The games console 110 is an example of a data processing apparatus.

The games console 110 comprises a central processing unit or CPU 20. This may be a single or multi core processor, for example comprising eight cores as in the PS5. The games console also comprises a graphical processing unit or GPU 30. The GPU can be physically separate to the CPU, or integrated with the CPU as a system on a chip (SoC) as in the PS5.

The games console also comprises random access memory, RAM 40, and may either have separate RAM for each of the CPU and GPU, or shared RAM as in the PS5. The or each RAM can be physically separate, or integrated as part of an SoC as in the PS5. Further storage is provided by a disk 50, either as an external or internal hard drive, or as an external solid state drive (SSD), or an internal SSD as in the PS5.

The games console may transmit or receive data via one or more data ports 60, such as a universal serial bus (USB) port, Ethernet® port, WiFi® port, Bluetooth® port or similar, as appropriate. It may also optionally receive data via an optical drive 70.

Interaction with the games console is typically provided using one or more instances of the controller 140, such as the DualSense® handheld controller in the case of the PS5. In an example, communication between each controller 140 and the games console 110 occurs via the data port(s) 60.

Audio/visual (A/V) outputs from the games console are typically provided through one or more A/V ports 90, or through one or more of the wired or wireless data ports 60. The A/V port(s) 90 may also receive audio/visual signals output by the integrated camera and microphone 120, for example. The microphone is optional and/or may be separate to the camera. Thus, the integrated camera and microphone 120 may instead be a camera only. The camera may capture still and/or video images.

Where components are not integrated, they may be connected as appropriate either by a dedicated data link or via a bus 200.

As explained, examples of a device for displaying images output by the game console 110 are the display device 100 and the HMD 130. The HMD is worn by a user 201. In an example, communication between the display device 100 and the games console 110 occurs via the A/V port(s) 90 and communication between the HMD 130 and the games console 110 occurs via the data port(s) 60.

The controller 140 is an example of a peripheral device for allowing the games console 110 to receive input from and/or provide output to the user. Examples of other peripheral devices include wearable devices (such as smartwatches, fitness trackers and the like), microphones (for receiving speech input from the user) and headphones (for outputting audible sounds to the user).

FIG. 2B shows some example components of a peripheral device 205 for receiving input from a user. The peripheral device comprises a communication interface 202 for transmitting wireless signals to and/or receiving wireless signals from the games console 110 (e.g. via data port(s) 60) and an input interface 203 for receiving input from the user. The communication interface 202 and input interface 203 are controlled by control circuitry 204.

In an example, if the peripheral device 205 is a controller (like controller 140), the input interface 203 comprises buttons, joysticks and/or triggers or the like operable by the user. In another example, if the peripheral device 205 is a microphone, the input interface 203 comprises a transducer for detecting speech uttered by a user as an input. In another example, if the peripheral device 205 is a fitness tracker, the input interface 203 comprises a photoplethysmogram (PPG) sensor for detecting a heart rate of the user as an input. The input interface 203 may take any other suitable form depending on the type of input the peripheral device is configured to detect.

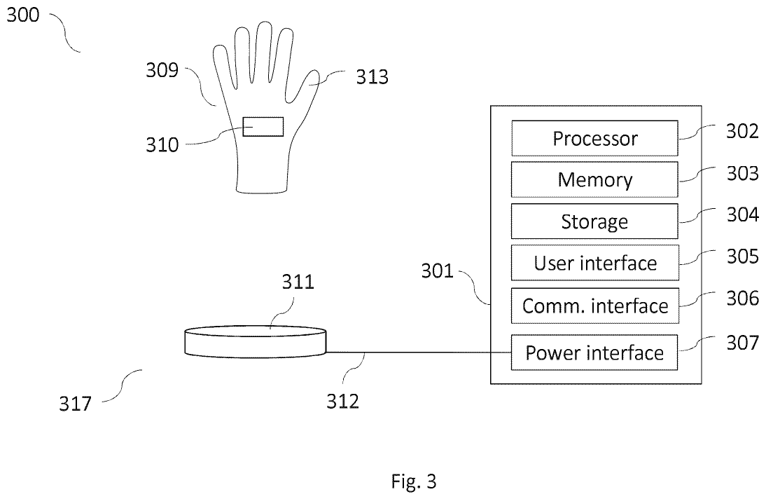

FIG. 3 shows an example peripheral system 300 according to the present technique. The peripheral system comprises a plurality of peripheral devices, including a glove 309 and an electromagnetic station 317. The electromagnetic station 317 comprises an electromagnetic pad 311 and controller 301. In this example, the pad 311 and controller 301 are separate units connected by a wire 312. However, the controller 301 may instead be comprised as part of the pad 311, for example.

The glove 309 comprises a wearable portion 313 to be worn on the hand of a user. The wearable portion is made of a suitable natural or synthetic fabric (such as cotton or polyester) or a mix of the two. The glove 309 also comprises a plate 310 comprising a suitable ferromagnetic material such as iron or steel. In an example, a portion of the ferromagnetic material of the plate 310 is exposed to enable physical contact with a magnet (not shown in FIG. 3) to allow a closed magnetic circuit to be created. The plate 310 is secured to the wearable portion using any suitable means, such as via an adhesive or by being secured around its periphery in an open pouch of the wearable portion (the pouch still allowing the portion of the ferromagnetic material to be exposed), for example.

The controller 301 comprise a processor 302 for executing electronic instructions, a memory 303 for storing the electronic instructions to be executed and electronic input and output information associated with the electronic instructions, a storage medium 304 (e.g. a solid state storage medium) for long term storage of digital information, a user interface 305 (e.g. a touch screen and/or buttons) for receiving commands from and/or outputting information to a user, a communication interface 306 for sending electronic information to and/or receiving electronic information from one or more other apparatuses and a power interface 307 for supplying electrical power to the electromagnetic pad 311. The controller 301 itself is supplied with electrical power from a mains power supply, for example. Each of the processor 302, memory 303, storage medium 304, user interface 305, communication interface 306 and power interface 307 are implemented using appropriate circuitry, for example. The processor 302 controls the operation of each of the memory 303, storage medium 304, user interface 305, communication interface 306 and power interface 307. In this example, the communication interface 306 is connectable to the data port(s) 60 of the games console 110 (e.g. via a suitable wired or wireless connection) so as to be able to send electronic information to and/or receive electronic information from the games console 110.

Power is supplied from the power interface 307 (under control of the processor 302) to the electromagnetic pad 311 via electrically conductive wire 312. The power is supplied to one or more electromagnets of the pad 311.

With the present technique, a user wears the glove 309 on one of their hands while playing a video game (such as an AR or VR video game). The user is able to control a virtual object to be picked up in the video game by moving the hand wearing the glove accordingly.

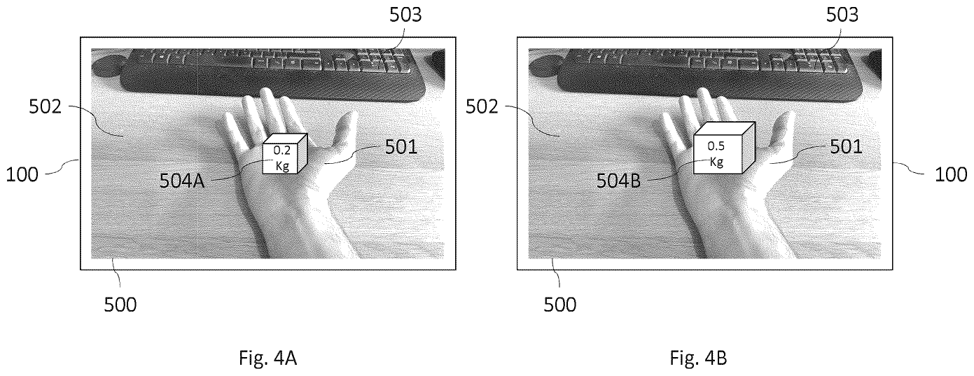

This is exemplified in FIGS. 4A and 4B, in which the visual output 500 of an AR video game is shown. In this example, for ease of explanation, the frame 500 is displayed in two-dimensional (2D) form on display device 100. However, in reality, the visual output may be displayed in three-dimensional (3D) form using an HMD or the like worn by the user. This helps provide a more immersive experience.

The visual output 500 includes a mix of real features (e.g. captured by a camera (not shown) included in the HMD), including table top 502 and keyboard 503, and virtual features (e.g. superimposed on the images captured by the HMD camera), including virtual hand 501 and weights 504A and 504B.

The virtual hand 501 is controlled to mimic the movements of the hand of the user wearing the glove. For example, the user may cause the virtual hand 501 to lift up the virtual objects 504A and 504B by making a corresponding lifting motion with their real hand. This is enabled, for example, by the games console 110 processing, in real time, images of the user's hand wearing the glove captured by the camera 120 to recognise the glove in the image, determine its position and orientation and adjust the position and orientation of the virtual hand 501 displayed as part of the visual output 500 accordingly. Various techniques for controlling the position and orientation of a virtual object based on the position and orientation of a real object in real time based on captured images of the real object are known in the art and thus not discussed here.

A problem, however, is that, even though the virtual hand 501 mimics the movement of the hand of the user when lifting the virtual objects 504A and 504B, thereby improving the immersive experience of the user in the AR world, the user feels no distinction in their real hand between different objects. In particular, the user feels no distinction between objects of different masses. Thus, although virtual object 504A has a mass of 0.2 Kg and virtual object 504B has a mass of 0.5 Kg, the user experiences no physical difference between these two virtual objects in their real hand when performing a lifting motion. There is therefore a desire to address this problem to make the user's experience more immersive.

In order to improve the user's immersive experience, a variable magnetic field generated by the pad 311 exerts an attractive magnetic force on the plate 310 of the glove 309 to simulate the weight of a virtual object. This allows the user to experience a greater physical resistance when performing a lifting motion with their hand to cause a heavier virtual object (e.g. virtual object 504B) to be lifted in the game and a smaller physical resistance when performing a lifting motion with their hand to cause a lighter virtual object (e.g. virtual object 504A) to be lifted in the game. Thus, heavier virtual objects feel heavier and lighter objects feel lighter to the user. The immersive experience of the user is therefore improved.

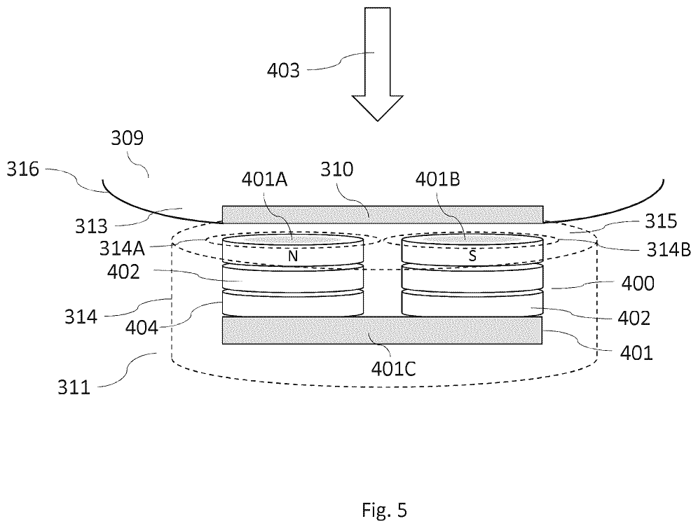

FIG. 5 shows a first example of an interaction between the pad 311 and plate 310 of the glove 309. The pad comprises a housing 314 and inside the housing is an electromagnet 400. The electromagnet comprises a core 401 comprising two legs 401A and 401B and a connecting portion 401C connecting the legs. In an example, each of the legs 401A and 401B and connecting portion 401C comprise a suitable ferromagnetic material (such as iron or steel) to enable the legs 401A and 401B and connecting portion 401C to form part of a magnetic circuit.

An electrically conductive coil 404 is formed around the legs 401A and 401B. The coil comprises a plurality of turns 402 around each of the legs 401A and 401B and the power interface 307 of the controller 301 supplies electrical power to the coil via the wire 312. In an example, the coil 404 is an extension of the wire 312. When power is supplied to the coil, a magnetic field is generated by the electromagnet 400. In this example, the leg 401A forms a north (N) pole of the magnetic field and the leg 401B forms a south(S) pole of the magnetic field.

A top surface 315 of the housing 314 comprises openings 401A and 401B to expose a top surface of the legs 401A and 401B, respectively. A rear side 316 of the glove 309 comprises the exposed plate 310. The rear side 316 is the side of the glove which, when worn, is adjacent the back of the user's hand rather than adjacent the user's palm.

Thus, when the user wears the glove and rests the hand wearing the glove on the top surface 315 of the housing 314 with the palm of their hand facing upwards, the exposed surfaces of the legs 401A and 401B make contact with the exposed plate 310. When power is supplied to the electromagnetic 400, the core 401 and plate 310 form a closed magnetic circuit and a downward magnetic force (in direction of arrow 403) is exerted on the glove 309 (and therefore on the user's hand wearing the glove). The user therefore experiences a resistance when attempting to lift their hand away from the pad 311. This helps mimic the weight of a virtual object lifted by the user in the game. Furthermore, by adjusting the strength of the electromagnet (by adjusting the current supplied to the coil 400), a greater or smaller downward magnetic force may be exerted on the glove, thereby allowing objects of different weights (such as objects 401A and 401B) to be associated with correspondingly different levels of resistance. The immersive experience of the user is therefore improved.

In an example, the processor 302 controls the current supplied to the coil 400 of the pad 311 (and therefore the downward magnetic force exerted on the glove when resting on the pad 311) in the following way.

It is known that, for a closed magnetic circuit (as occurs when the exposed surfaces of the legs 401A and 401B make contact with the exposed plate 310), the generated magnetic force F is given by:

$$F = \frac{{μ}^{2} {N}^{2} {I}^{2} A}{2 {μ}_{0} {L}^{2}} \qquad [ Equation 1 ]$$

N is the number of turns of the coil 400. For simplicity, N=6 turns (3 turns on each of legs 401A and 401B) in the example of FIG. 5. However, in reality, N may be much larger and may incorporate several hundred turns (depending on the thickness of the wire used for the coil and the length of each of the legs 401A and 401B, for example).

I is the current supplied to the coil (in amps).

L is the length of the core 301 (in metres). In the example of FIG. 5, L is measured starting from the exposed surface of leg 401A, through leg 401A, through the connecting portion 401C and through leg 401B ending at the exposed surface of leg 401B.

A is the combined area of the exposed surfaces of the legs 401A and 401B (in metres squared) which make contact with the plate 301.

μ₀ is the magnetic permeability of a vacuum (fixed at μ₀=4π(10⁻⁷) newtons/amps²)

μ is the magnetic permeability of the core (in newtons/amps²). This varies depending on the core material and the magnitude of the generated magnetic field. The magnetic field magnitude B (in Tesla) is given by:

$$B = \frac{NI μ}{L} \qquad [ Equation 2 ]$$

Thus, μ can be calculated for a given value of B, N, I and L. In an example, N and L are fixed and B is measured (e.g. using a magnetometer) for different known currents I applied to the electromagnetic 400 in advance (the current being measured using an ammeter). This allows μ to be calculated for each known current I and, for a different (that is, untested) current value I, μ can be determined by a suitable regression model, such as a polynomial regression model. As long as a sufficient range and granularity of different measured values of the current I are used to train the regression model (e.g. 20, 50 or 100 values of the current measured, in equal intervals, from zero to the maximum current that can be safely applied by the power interface 307), μ may be determined to a suitable level of accuracy for any given value of the current I. In an example, data and code representing the regression model are stored in the storage medium 304.

When a polynomial regression model is used, the value of μ is given by a polynomial equation (which may be referred to as a function “poly”) with the current I as the variable and with coefficients determined using regression based on the measured values of I and corresponding values of μ. This may be represented as:

$$μ = poly ( I ) \qquad [ Equation 3 ]$$

In order for the magnetic force to approximate the weight of a virtual object, it must be that

$$F = mg \qquad [ Equation 4 ]$$

Here, m is the mass of the object (e.g. m=0.2 Kg for virtual object 504A and m=0.5 Kg for virtual object 504B) and g is the magnitude of the acceleration due to gravity (approximately 9.8 ms⁻²).

Substituting [Equation 3] and [Equation 4] into [Equation 1] gives:

$$mg = \frac{{[ poly ( I ) ]}^{2} {N}^{2} {I}^{2} A}{2 {μ}_{0} {L}^{2}} \qquad [ Equation 5 ]$$

Rearranging gives:

$$I * [ poly ( I ) ] = \sqrt{\frac{2 {μ}_{0} {L}^{2} mg}{{N}^{2} A}} \qquad [ Equation 6 ]$$

I*[poly (I)] is a polynomial of one order higher than poly (I), which may be referred to as poly2 (I). The current I to be applied to the coil 400 to provide a resistance to simulate the weight of an object of mass m may therefore be obtained by solving the polynomial equation:

$$poly 2 ( I ) - \sqrt{\frac{2 {μ}_{0} {L}^{2} mg}{{N}^{2} A}} = 0 \qquad [ Equation 7 ]$$

In an example where poly (I) is a quadratic equation and therefore poly2 (I) is a cubic equation, the current I to be supplied to the coil 400 to simulate the resistance of lifting an object of mass m can be calculated by solving the cubic equation:

$$α {I}^{3} + β {I}^{2} + γ I - \sqrt{\frac{2 {μ}_{0} {L}^{2} mg}{{N}^{2} A}} = 0 \qquad [ Equation 8 ]$$

Here, α, β, and γ are determined when training the regression model poly (I). Metadata indicating the mass m (and therefore the weight w under gravity, given that w=mg where g is the acceleration due to gravity) of the object to be lifted (e.g. 0.2 for object 504A and 0.5 for object 504B) may be supplied from the games console 110 to the controller 301 via the data port(s) 60 and communication interface 306. The values μ₀, L, g, N and A are fixed and stored in advance (e.g. in storage medium 304). For a given value m, the processor 302 thus solves [Equation 8] (using any suitable root-finding algorithm, such as Newton's method, for example) to determine I and controls the power interface to supply a current (that is, a DC current) equal to the determined value of I to the coil 400 (e.g. by supplying a particular voltage determined based on the determined value of the current and a known resistance of the coil 400).

Given the nature of polynomials of order 2 and higher, multiple values of I may be determined by solving [Equation 8]. In this case, only the positive value of I is used. If there are multiple positive values of I, the maximum of those positive values which the power interface 307 is able to safely supply is used. A maximum current that the power interface 307 is able to safely supply is set in advance and this value is stored in the storage medium 304 for reference by the processor 302, for example.

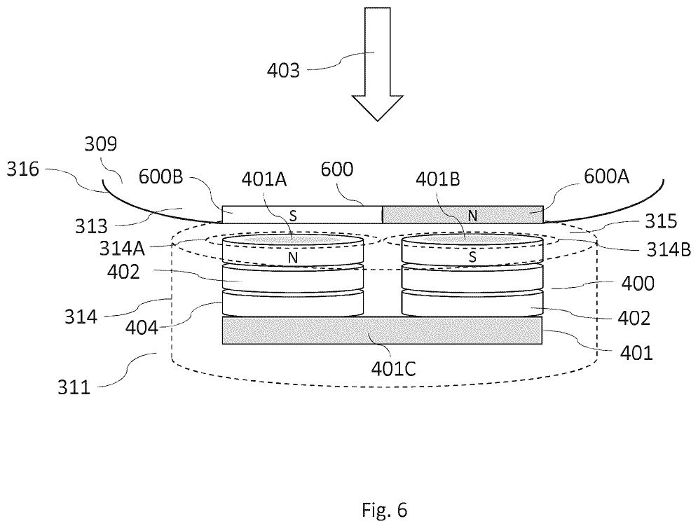

FIG. 6 shows a variation of the example of FIG. 5. In the example of FIG. 5, a soft magnetic material (which does not tend to remain magnetised when an external magnetic field is removed) is used for the plate 310. In FIG. 6, however, the plate 310 is replaced with a permanent magnet 600 (e.g. a bar magnet with a similar plate-like shape to the plate 310) with a permanent north pole 310A and a permanent south pole 310B. The magnetic field generated by the permanent magnet 600 (the permanent magnet being a hard magnetic material which tends to remain magnetised when an external magnetic field is removed) increases the total strength of the magnetic force exerted on the glove 309 by the electromagnetic 400 for a given amount of supplied current. This allows the weight of heavier objects to be simulated with less current, thereby reducing the energy consumption of the pad 311.

When the permanent magnet 600 is used instead of the plate 310, a measured magnetic field magnitude at the surface of each pole 600A and 600B (e.g. at a point with the maximum measured magnetic field magnitude at each pole) is taken into account when determining μ for a given I, N, L and B using [Equation 2]. For example, the value B=B_{elec}+Bₚₑᵣₘ may be used in [Equation 2], where B_{elec} is the measured magnetic field magnitude of the electromagnet (which changes with the current I) and Bₚₑᵣₘ is the measured magnetic field magnitude of the permanent magnet 600 (which does not change). This allows the regression model relating μ and I to take into account the magnetic field (e.g. that of [Equation 3]) of the permanent magnet 600.

When the permanent magnet 600 is used instead of the plate 310, to help correct orientation of the magnet 600 with the electromagnet 400 of the pad 311 (so that the N pole of the electromagnet is aligned with the S pole of the permanent magnet and the S pole of the electromagnet is aligned with the N pole of the permanent magnet), a top surface of the pad 311 may comprise a visual indicator (e.g. an arrow) indicating the corresponding correct orientation of the glove.

Alternatively, or in addition, an orientation procedure may be undertaken. In this case, the user controls a small amount of current to be supplied to the electromagnetic 400 for a predetermined period of time (e.g. 5 seconds) while they rest the glove 309 on the pad 311. The amount of current supplied corresponds to a force applied to the permanent magnet 600 (and therefore the glove 309) which can be felt by the user so as to guide them to the correct orientation of the glove. The correct orientation will be that at which the glove 309 feels as if it has the most weight (and, unlike 180° out from the correct orientation, the glove 309 is not repelled away from the pad 311). In an example, the current supplied during the orientation procedure corresponds to a mass of 0.2 Kg. The orientation procedure may be initiated by pressing an orientation control (e.g. a button or the like, not shown) on the pad 311 or by controlling this via a suitable menu option of the games console 110 (e.g. using controller 140).

In an example, the pad 311 may comprise weight(s) (not shown) within the housing 314 so its weight is greater than a maximum magnetic force applied to the glove 309 by the electromagnet 400. This ensures the pad 311 is not inadvertently lifted as the user lifts the hand wearing the glove 309 to control the lifting of a virtual object in the video game. The risk of damage to the pad is therefore reduced. Alternatively, or in addition, the pad 311 may be secured to a surface (e.g. coffee table, desk or the like) using a suitable releasable fastener (not shown), such as one or more suction pads, to prevent it from being lifted up with the glove.

To reduce power consumption of the electromagnet 400 and reduce user exposure to magnetic fields, the power interface 307 may be controlled to supply current to the pad 311 only when it is determined that the glove 309 is in contact with (or, more generally, in proximity to) the top surface 315 of the pad.

In an example, this is achieved based on images of the glove 309 and pad 311 captured by the camera indicating that the glove 309 is resting on the top surface 315 of the pad. This is enabled, for example, by the games console 110 processing, in real time, images captured by the camera 120 of the pad 311 and user wearing the glove 309 to recognise the pad and glove and detect when the position and orientation of the glove relative to the position and orientation of the pad indicates the side 316 of the glove comprising the plate 310 (or magnet 600) makes contact with the top surface 315 of the pad (or, for example, is within a predetermined distance of the top surface of the pad, e.g. 10 mm or less). Various techniques for determining the position and orientation of an object in real time based on captured images of that object are known in the art and thus not discussed here. Information (e.g. a flag) indicating that the glove and pad are making contact (or are within the predetermined distance) is provided from the games console 110 to the controller 301 via the communication interface 306. The processor 302 then controls the power interface 307 to supply power to the electromagnet 400 of the pad only in response to this information being received.

In another example, the pad 311 and/or glove 309 itself may comprise a device (not shown) for detecting when the glove has made contact with (or is within a predetermined distance of) the pad. For example, the pad 311 may comprise an active (that is, powered, e.g. by power interface 307) near-field communication (NFC) initiator adjacent its top surface 315 and the glove 309 may comprise a passive NFC transponder (powered by the electromagnetic field emitted by the NFC initiator of the pad 311) adjacent its rear side 316. When the NFC initiator of the pad and the NFC transponder are in range (so the NFC transponder can respond to detection of an electromagnetic field emitted by the NFC initiator), this is detected by the NFC initiator and indicated (e.g. via a control line, not shown) to the processor 302. The processor 302, in turn, then controls the power interface 307 to supply the appropriate amount of current to the electromagnetic 400 of the pad 311 (e.g. depending on the mass of the virtual object being lifted in the game).

In an example, to make this arrangement more robust, the NFC transponder may respond with a code (e.g. a universal unique identifier, UUID) known in advance by the processor 302 to be uniquely associated with the glove 309 (or with compatible gloves generally). For example, the known code may be stored in advance in the storage medium 304. The power interface 307 is then controlled to supply power to the electromagnet 400 only if the detected code matches the known code. This helps prevent, for example, power being supplied to the electromagnet in response to detection of an unrelated NFC transponder (e.g. that of a credit card or the like placed on the surface 315) by the NFC initiator of the pad 311.

The present technique may be extended to both hands of the use. So, for example, the user wears a glove 309 on each hand and there is either an additional pad 311 or the single pad 311 comprises an electromagnet for each glove. The present technique may also be extended to other devices, including other wearable devices (e.g. shoes, bodysuits, helmets or the like) and gaming controllers (e.g. controller 140) to help provide a feeling of weight and/or inertia to the user. In any case, one or more ferromagnetic plates (and/or permanent magnets) are mounted on or in the other device so as to be able to interact with one or more pads like pad 311 each containing one or more electromagnets. The pad(s) may be mounted horizontally, vertically or at any orientation (e.g. using a suitable frame) so that a magnetic field generated by the pad(s) when current is supplied to them may interact with the ferromagnetic plate(s) and/or permanent magnet(s) in any desirable way. In the case of ferromagnetic plate(s), the generated magnetic field will cause an attraction between the pad(s) and plate(s). In the case of permanent magnet(s), the generated magnetic field will cause an attraction or repulsion between the pad(s) and magnet(s). This provides enhanced flexibility in the way magnetic fields can be generated and manipulated to enable a user to experience weight and/or inertia as they play an AR or VR video game.

In the above examples, the plate 310 (or magnet 600—this paragraph mentions the plate 310, but is equally as applicable to the magnet 600 if this is what is used) is fitted so it cannot move relative to the wearable portion 313 of the glove. In another example, to help keep the plate 310 at a particular orientation (e.g. substantially parallel with the top surface 315 of the pad 311), the plate 310 may be mounted in a gyroscopic frame (not shown) attached to the glove 309 which keeps the plate 310 at that particular orientation in space even if the orientation of the glove 309 is changed (e.g. if the user moves their hand so the back of their hand is no longer substantially parallel with the top surface 315 of the pad). The gyroscopic frame comprises one or more gyroscopes which keep the plate 310 at the particular orientation. This allows the magnetic force between the pad 311 and plate 310 to remain predictable and in the same downward direction even if the orientation of the glove is changed, thereby mimicking the downward pull of gravity. This technique of using gyroscopes may be applied more generally (e.g. to other wearable devices, controllers or the like) to keep the plate(s) and/or permanent magnet(s) orientated at a particular orientation with respect to the electromagnetic pad(s). This helps allow the calculated magnetic force for a given current supplied to the electromagnet(s) to be applied consistently even as the user moves relative to the electromagnet(s).

In the above examples, whenever a ferromagnetic material is mentioned, it will be appreciated that a ferrimagnetic material could also be used instead or in addition.

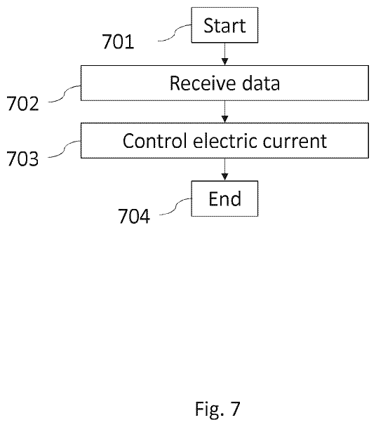

An example method according to the present technique is shown in FIG. 7. The method of FIG. 7 is a computer-implemented method of controlling a video game peripheral device comprising an electromagnet, such as the electromagnetic station 317 comprising electromagnetic pad 311 (which, in turn, comprises electromagnet 400). It is executed by suitable circuitry, such as by the processor 302 of controller 301.

The method starts at step 701. At step 702, data (e.g. indicating the mass m of virtual object 504A or 504B) is received (e.g. via communication interface 306) from a data processing apparatus (e.g. games console 110) executing a video game application.

At step 703, based on the received data, an electric current supplied to the electromagnet is controlled to control a magnetic interaction between the electromagnet (e.g. electromagnet 400) and a magnetic material (e.g. plate 310 or permanent magnet 600) of a second video game peripheral device (e.g. glove 309) wearable or holdable by a user. For example, the electric current supplied to the electromagnet may cause the electromagnet and magnetic material of the second video game peripheral device to be attracted to each other with a magnetic force equal to a weight of a virtual object in a video game, as discussed above. The method starts at step 704.

Example(s) of the present technique are defined by the following numbered clauses:
1. A video game peripheral device comprising an electromagnet and circuitry, the circuitry being configured to: receive data from a data processing apparatus executing a video game application; based on the received data, control an electric current supplied to the electromagnet to control a magnetic interaction between the electromagnet and a magnetic material of a second video game peripheral device wearable or holdable by a user.
2. A video game peripheral device according to clause 1, wherein: the received data indicates a weight of a virtual object in a video game; and the electric current supplied to the electromagnet causes the electromagnet and magnetic material of the second video game peripheral device to be attracted to each other with a magnetic force equal to the weight of the virtual object.
3. A video game peripheral device according to clause 2, wherein the electric current I supplied to the electromagnet is calculated using:

$$F = \frac{{μ}^{2} {N}^{2} {I}^{2} A}{2 {μ}_{0} {L}^{2}}$$

where F is the weight of the virtual object, N is a number of turns of a coil of the electromagnet, L is a length of a core of the electromagnet, A is an area of contact between the core of the electromagnet and the magnetic material of the second video game peripheral device, μ₀ is a magnetic permeability of a vacuum and μ is a magnetic permeability of the core of the electromagnet.
4. A video game peripheral device according to clause 3, wherein a relationship between u and I is determined using a trained regression model.
5. A video game peripheral device according to any preceding clause, wherein the trained regression model is a polynomial regression model.
6. A video game peripheral device according to any preceding clause, wherein the circuitry is configured to control electric current to be supplied to the electromagnet only when the magnetic material of the second video game peripheral device is in proximity to the electromagnet.
7. A video game peripheral device according to clause 6, wherein the circuitry is configured to determine that the second video game peripheral device is in proximity to the electromagnet based on a captured image of the video game peripheral device and second video game peripheral device.
8. A video game peripheral device according to clause 6, wherein the circuitry is configured to determine that the second video game peripheral device is in proximity to the electromagnet based on a near-field communication, NFC, transmission between the video game peripheral device and second video game peripheral device.
9. A video game peripheral device according to any preceding clause, wherein the wearable or holdable video game peripheral device is a glove.
10. A video game peripheral device according to any one of clauses 1 to 8, wherein the wearable or holdable video game peripheral device is a video game controller.
11. A video game peripheral device according to any one of clauses 1 to 8, wherein the wearable or holdable video game peripheral device is a bodysuit.
12. A video game peripheral system comprising: a video game peripheral device according to any preceding clause; and a second video game peripheral device wearable or holdable by a user and comprising a magnetic material.
13. A method of controlling a video game peripheral device comprising an electromagnet, the method comprising: receiving data from a data processing apparatus executing a video game application; based on the received data, controlling an electric current supplied to the electromagnet to control a magnetic interaction between the electromagnet and a magnetic material of a second video game peripheral device wearable or holdable by a user.
14. A program for controlling a computer to perform a method according to clause 13.
15. A storage medium storing a program according to clause 14.

Numerous modifications and variations of the present disclosure are possible in light of the above teachings. It is therefore to be understood that, within the scope of the claims, the disclosure may be practiced otherwise than as specifically described herein.

In so far as embodiments of the disclosure have been described as being implemented, at least in part, by one or more software-controlled information processing apparatuses, it will be appreciated that a machine-readable medium (in particular, a non-transitory machine-readable medium) carrying such software, such as an optical disk, a magnetic disk, semiconductor memory or the like, is also considered to represent an embodiment of the present disclosure. In particular, the present disclosure should be understood to include a non-transitory storage medium comprising code components which cause a computer to perform any of the disclosed method(s).

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more computer processors (e.g. data processors and/or digital signal processors). The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to these embodiments. Additionally, although a feature may appear to be described in connection with particular embodiments, one skilled in the art would recognize that various features of the described embodiments may be combined in any manner suitable to implement the present disclosure.

1. A video game peripheral device comprising an electromagnet and circuitry, the circuitry being configured to:
receive data from a data processing apparatus executing a video game application;
based on the received data, control an electric current supplied to the electromagnet to control a magnetic interaction between the electromagnet and a magnetic material of a second video game peripheral device wearable or holdable by a user.

2. A video game peripheral device according to claim 1, wherein:
the received data indicates a weight of a virtual object in a video game; and
the electric current supplied to the electromagnet causes the electromagnet and magnetic material of the second video game peripheral device to be attracted to each other with a magnetic force equal to the weight of the virtual object.

3. A video game peripheral device according to claim 2, wherein the electric current I supplied to the electromagnet is calculated using:
$$F = \frac{{μ}^{2} {N}^{2} {I}^{2} A}{2 {μ}_{0} {L}^{2}}$$
where F is the weight of the virtual object, N is a number of turns of a coil of the electromagnet, L is a length of a core of the electromagnet, A is an area of contact between the core of the electromagnet and the magnetic material of the second video game peripheral device, μ₀ is a magnetic permeability of a vacuum and μ is a magnetic permeability of the core of the electromagnet.

4. A video game peripheral device according to claim 3, wherein a relationship between μ and I is determined using a trained regression model.

5. A video game peripheral device according to claim 1, wherein the trained regression model is a polynomial regression model.

6. A video game peripheral device according to claim 1, wherein the circuitry is configured to control electric current to be supplied to the electromagnet only when the magnetic material of the second video game peripheral device is in proximity to the electromagnet.

7. A video game peripheral device according to claim 6, wherein the circuitry is configured to determine that the second video game peripheral device is in proximity to the electromagnet based on a captured image of the video game peripheral device and second video game peripheral device.

8. A video game peripheral device according to claim 6, wherein the circuitry is configured to determine that the second video game peripheral device is in proximity to the electromagnet based on a near-field communication, NFC, transmission between the video game peripheral device and second video game peripheral device.

9. A video game peripheral device according to claim 1, wherein the wearable or holdable video game peripheral device is a glove.

10. A video game peripheral device according to claim 1, wherein the wearable or holdable video game peripheral device is a video game controller.

11. A video game peripheral device according to claim 1, wherein the wearable or holdable video game peripheral device is a bodysuit.

12. A video game peripheral system comprising:
a video game peripheral device comprising an electromagnet and circuitry, the circuitry being configured to;
receive data from a data processing apparatus executing a video game application, and
based on the received data, control an electric current supplied to the electromagnet to control a magnetic interaction between the electromagnet and a magnetic material of a second video game peripheral device wearable or holdable by a user; and
a second video game peripheral device wearable or holdable by a user and comprising a magnetic material.

13. A method of controlling a video game peripheral device comprising an electromagnet, the method comprising:
receiving data from a data processing apparatus executing a video game application;
based on the received data, controlling an electric current supplied to the electromagnet to control a magnetic interaction between the electromagnet and a magnetic material of a second video game peripheral device wearable or holdable by a user.

14. (canceled)

15. A non-transitory computer-readable storage medium storing a program for controlling a computer to perform a method of controlling a video game peripheral device comprising an electromagnet, the method comprising:
receiving data from a data processing apparatus executing a video game application;
based on the received data, controlling an electric current supplied to the electromagnet to control a magnetic interaction between the electromagnet and a magnetic material of a second video game peripheral device wearable or holdable by a user.
